(19) United States
(12) Patent Application Publication
(10) Pub. No.: US 2024/0104170 A1
(43) Pub. Date: Mar. 28, 2024

(54) LATE FUSION MULTI-VIEW CLUSTERING METHOD AND SYSTEM BASED ON LOCAL MAXIMUM ALIGNMENT

(71) Applicant: ZHEJIANG NORMAL UNIVERSITY, Jinhua, Zhejiang (CN)

(72) Inventors: Xinzhong ZHU, Jinhua (CN); Huiying XU, Jinhua (CN); Miaomiao LI, Jinhua (CN); Weixuan LIANG, Jinhua (CN); Hongbo LI, Jinhua (CN); Jianping YIN, Jinhua (CN); Jianmin ZHAO, Jinhua (CN)

(73) Assignee: ZHEJIANG NORMAL UNIVERSITY, Jinhua, Zhejiang (CN)

(21) Appl. No.: 18/274,220

(22) PCT Filed: Jun. 15, 2022
(86) PCT No.: PCT/CN2022/098950

§ 371 Date: Jul. 26, 2023

(30) Foreign Application Priority Data
Jun. 24, 2021 (CN) 202110706944.0
Nov. 10, 2021 (CN) 202111326425.8

(51) Int. Cl. G06F 18/23213

(52) U.S. Cl. CPC G06F 18/23213

(57) ABSTRACT

A late fusion multi-view clustering method and system based on local maximum alignment are provided. The late fusion multi-view clustering method based on local maximum alignment includes the following steps: S1: acquiring a clustering task and a target data sample; S2: initializing a permutation matrix of each view and a combination coefficient of each view, and performing average partition of kernel k-means clustering on an average kernel to obtain a neighbor matrix of each view; S3: calculating basic partition of each view, and establishing a late fusion multi-view clustering objective function based on maximum alignment; S4: acquiring basic partition having local information, and establishing a late fusion multi-view clustering objective function based on local maximum alignment; S5: solving the established late fusion multi-view clustering objective function based on local maximum alignment in a cyclic manner to obtain optimal partition; and S6: performing k-means clustering on the optimal partition.

### CROSS REFERENCE TO THE RELATED APPLICATIONS

This application is the national phase entry of International Application No. PCT/CN2022/098950, filed on Jun. 15, 2022, which is based upon and claims priority to Chinese Patent Application No. 202110706944.0, filed on Jun. 24, 2021; and Chinese Patent Application No. 202111326425.8, filed on Nov. 10, 2021, the entire contents of which are incorporated herein by reference.

### TECHNICAL FIELD

The present application relates to the technical field of machine learning, and in particular to a late fusion multi-view clustering method and system based on local maximum alignment.

### BACKGROUND

With the development of multi-source information collection technology, the collected data can be represented in various ways, for example, a video can have image data and sound data from different angles. Such data, in the field of machine learning, is referred to as multi-view data. The full and reasonable application of such data has always been an important topic in theoretical research and scientific practice. The clustering algorithm plays an important role in the field of unsupervised learning in machine learning, and aims to perform disjoint partition on unlabeled data. Clustering with multiple views can extract sample information from different angles, so that the clustering effect is better than that of a single view.

Multi-view clustering can be roughly classified into the following three types: i) Co-training multi-view clustering (A. Blum and T. Mitchell, “Combining labeled and unlabeled data with co-training”, in COLT 1998, pp. 92-100). This method, in addition to extracting information from each view, simultaneously seeks consistent clustering results across views. ii) Subspace clustering (X. Cao, C. Zhang, H. Fu, S. Liu, and H. Zhang, “Diversity-induced multi-view subspace clustering”, in CVPR 2015, pp. 586-594). This method aims to construct a consistent subspace through representation of different views to achieve the purpose of view fusion. iii) Multi-kernel clustering (M. Gönen and A. A. Margolin, “Localized data fusion for kernel kmeans clustering with application to cancer biology”, in NeurIPS 2014, pp. 1305-1313). The principle of this algorithm is to find the optimal combination coefficient of the base kernel by means of optimization, so as to achieve the purpose of improving the clustering effect.

The multi-kernel clustering algorithm in the above method has attracted much attention because of its strong interpretability and good effect. However, in the actual applications, the multi-kernel clustering algorithm has the following two disadvantages: first, the computational complexity and storage complexity is relatively high. Because several kernel matrices need to be stored and calculated, the space complexity of this type of algorithm is O(n\hat{ }2); the eigendecomposition of the kernel matrix is also required, resulting in a time complexity of O(n\hat{ }3). Secondly, a more complex optimization process increases the risk of getting trapped in a poor local optimum.

In order to overcome the above defects, the purposes of reducing complexity and simplifying optimization process are achieved. The late fusion multi-view clustering no longer uses the kernel matrix for fusion, but fuses more lightweight basic partitions. The late fusion multi-view clustering based on maximum alignment (S. Wang, X. Liu, E. Zhu, et al., “Multi-view clustering via late fusion alignment maximization”, in IJCAI 2019, pp. 3778-3784) not only reduces the computational complexity from O(n\hat{ }3) to O(n), but also further improves the clustering effect. The efficient and effective regularized incomplete multi-view clustering algorithm (Liu X, Li M, Tang C, et al., “Efficient and Effective Regularized Incomplete Multi-view Clustering”, in TPAMI, 2020, preprint) uses the late fusion method to process the incomplete multi-view clustering problem, so that the clustering effect exceeds the same type of algorithm, and lower computational complexity is achieved. However, this method does not take into account the local structure of the data. At present, there is no method that can integrate the two advantages of fast operation speed and local data structure of late fusion.

### SUMMARY

For the defects of the prior art, an objective of the present application is to provide a late fusion multi-view clustering method and system based on local maximum alignment.

In order to achieve the above objective, the present application uses the following technical solutions.

A late fusion multi-view clustering method based on local maximum alignment includes the following steps:
S1: acquiring a clustering task and a target data sample;
S2: initializing a permutation matrix of each view and a combination coefficient of each view, and performing average partition of kernel k-means clustering on an average kernel to obtain a neighbor matrix of each view;
S3: calculating basic partition of each view, and establishing a late fusion multi-view clustering objective function based on maximum alignment;
S4: acquiring basic partition having local information, and establishing a late fusion multi-view clustering objective function based on local maximum alignment by combining the neighbor matrix of each view and the step S3;
S5: solving the established late fusion multi-view clustering objective function based on local maximum alignment in a cyclic manner to obtain optimal partition after fusing each basic partition; and
S6: performing k-means clustering on the optimal partition to obtain a clustering result.

Further, the kernel k-means clustering in the step S2 is represented as:

$$\\ {min}_{{H}^{T} H = {I}_{k}} Tr ( K ( {I}_{m} - {HH}^{T} )$$

where H∈R^{n×k} represents a partition matrix solved according to the kernel matrix K; Iₘ represents an identity matrix with a dimension of m(∈N⁺); H^{T} represents the permutation of H; and Iₖ represents a k-dimensional identity matrix.

Further, the calculating basic partition of each view in the step S3 specifically includes: constructing different kernel matrices {Kₚ}ₚ₌₁^{m} for different views, and operating kernel k-means clustering to obtain the basic partition {Hₚ}ₚ₌₁^{m} of each view.

Further, the establishing a late fusion multi-view clustering objective function based on maximum alignment in the step S3 is represented as:

$$\\ {max}_{F , {\{ {W}_{p} \}}_{p = 1}^{m} , β} Tr ( {F}^{T} X ) + λ Tr ( {F}^{T} M )$$

$$\\ s . t . {F}^{T} F = {I}_{k} , {W}_{p}^{T} {W}_{p} = {I}_{k} , {‖ β ‖}_{2} = 1 , {β}_{p} \geq 0 , X = {\sum }_{p = 1}^{m} {β}_{p} {H}_{p} {W}_{p}$$

where F represents an optimized optimal partition; β represents a vector formed by the combination coefficients of each view, βₚ represents a coefficient of the p^{th} view, and {Wₚ}ₚ₌₁^{m} represents a permutation matrix of each view; m represents average partition obtained by performing kernel k-means clustering on the average kernel; F^{T} represents a permutation of F; W^{T} represents a permutation of W; Hₚ represents the basic partition of each view obtained by kernel k mean clustering; and m represents the number of views.

Further, the establishing a late fusion multi-view clustering objective function based on local maximum alignment in the step S4 is represented as:

$$\\ {max}_{F , {\{ {W}_{p} \}}_{p = 1}^{m} , β} {\sum }_{i = 1}^{n} ( Tr ( {F}^{T} {\sum }_{p = 1}^{m} {β}_{p} \tilde{H} {}_{p}^{( i )} {W}_{p} ) + λ Tr ( {F}^{T} {\tilde{M}}_{i} ) )$$

$$\\ s . t . \tilde{H} {}_{p}^{( i )} = {( {A}_{p}^{( i )} )}^{T} {H}_{p} , {\tilde{M}}_{i} = {( {A}_{p}^{( i )} )}^{T} M$$

$$\\ {F}^{T} F = {I}_{k} , {W}_{p}^{T} {W}_{p} = {I}_{k} , {‖ β ‖}_{2} = 1 , {β}_{p} \geq 0$$

where Aₚ⁽ⁱ⁾ represents an indicator matrix of τ neighbors in sample i in the p^{th} view, that is, a neighbor matrix of each view; n represents the number of samples; \tilde{H}ₚ⁽ⁱ⁾ represents a basic partition matrix with the i^{th} sample local information in the p^{th} view; {Wₚ}ₚ₌₁^{m} represents a permutation matrix of each view; λ represents a regularization parameter; \tilde{M}ᵢ represents an average partition matrix with the i^{th} sample local information; and (Aₚ⁽ⁱ⁾)^{T} represents a permutation of Aₚ⁽ⁱ⁾.

Further, the solving the established late fusion multi-view clustering objective function based on local maximum alignment in a cyclic manner in the step S5 specifically includes:
A1: fixing {Wₚ}ₚ₌₁^{m} and β, and optimizing F, where an optimization formula is represented as:

$$\\ {max}_{F} Tr ( {F}^{T} U ) , s . t . {F}^{t} F = {I}_{k}$$

where U=Σᵢ₌₁ⁿ(Σₚ₌₁^{m}βₚ\tilde{H}ₚ⁽ⁱ⁾Wₚ+λ\tilde{M}ᵢ), assuming that a singular value of the rank k of U is decomposed into U=SₖΣₖVₖ^{T}, where Sₖ∈R^{n×k} represents a left singular value vector, Eₖ∈R^{k×k} represents a diagonal matrix with singular values as elements, Vₖ∈R^{k×k} represents a right singular value vector, and then a closed-form solution F=SₖVₖ^{T} is obtained, and Vₖ^{T} represents Vₖ permutation;
A2: fixing F and β, optimizing {Wₚ}ₚ₌₁^{m}, and independently optimizing each Wₚ, where an optimization formula is represented as:

$$\\ {max}_{{W}_{p}} Tr ( {W}_{p}^{T} L ) , s . t . {W}_{p}^{T} {W}_{p} = {I}_{k}$$

where L=Σᵢ₌₁ⁿβₚ(\tilde{H}ₚ⁽ⁱ⁾)^{T}F, assuming that a singular value of L is decomposed into L=SΣV^{T}, where R^{k×k} represents a left singular value vector, Σ∈R^{k×k} represents a diagonal matrix with singular values as elements, V∈R^{k×k} represents a right singular value vector, and then a closed-form solution Wₚ=SV is obtained;
A3: fixing {Wₚ}ₚ₌₁^{m} and F, and optimizing β, where an optimization formula is represented as:

$$\\ {max}_{β} {\sum }_{p = 1}^{m} {β}_{p} {δ}_{p} , s . t . {‖ β ‖}_{2} = 1 , {β}_{p} \geq 0$$

where δₚ=Σᵢ₌₁ⁿTr(F^{T}\tilde{H}ₚ⁽ⁱ⁾Wₚ), a closed-form solution βₚ=δₚ/\sqrt{Σₚ₌₁^{m}δₚ²} is obtained by using a condition that the equal sign of the Cauchy-Bunyakovsky-Schwarz inequality is taken.

Further, in the step S5, the established late fusion multi-view clustering objective function based on local maximum alignment is solved in a cyclic manner, a termination condition of the circulation is represented as:

(obj^{(t-1)}−obj^{(t)}/obj^{(t)}≤ε

where obj^{(t-1)} and obj^{(t)} represent values of the objective function for the t^{th} iteration and t−1^{th} iteration; and ε represents the set precision.

Correspondingly, further provided is a late fusion multi-view clustering system based on local maximum alignment, which includes:
an acquisition module configured to acquire a clustering task and a target data sample;
an initialization module configured to initialize a permutation matrix of each view and a combination coefficient of each view, and perform average partition of kernel k-means clustering on an average kernel to obtain a neighbor matrix of each view;
a first establishment module configured to calculate basic partition of each view, and establish a late fusion multi-view clustering objective function based on maximum alignment;
a second establishment module configured to acquire basic partition having local information, and establish a late fusion multi-view clustering objective function based on local maximum alignment by combining the neighbor matrix of each view and the objective function in the first establishment module;
a solving module configured to solve the established late fusion multi-view clustering objective function based on local maximum alignment in a cyclic manner to obtain optimal partition after fusing each basic partition; and
a clustering module configured to perform k-means clustering on the optimal partition to obtain a clustering result.

Further, the establishing a late fusion multi-view clustering objective function based on maximum alignment in the first establishment module is represented as:

$$\\ {max}_{F , {\{ {W}_{p} \}}_{p = 1}^{m} , β} Tr ( {F}^{T} X ) + λ Tr ( {F}^{T} M )$$

$$\\ s . t . {F}^{T} F = {I}_{k} , {W}_{p}^{T} {W}_{p} = {I}_{k} , {‖ β ‖}_{2} = 1 , {β}_{p} \geq 0 , X = {\sum }_{p = 1}^{m} {β}_{p} {H}_{p} {W}_{p}$$

where F represents an optimized optimal partition; β represents a vector formed by the combination coefficients of each view, βₚ represents a coefficient of the p^{th} view, and {Wₚ}ₚ₌₁^{m} represents a permutation matrix of each view; m represents average partition obtained by performing kernel k-means clustering on the average kernel; F^{T} represents a permutation of F; W^{T} represents a permutation of W; Hₚ represents the basic partition of each view obtained by kernel k mean clustering; and m represents the number of views.

Further, the establishing a late fusion multi-view clustering objective function based on local maximum alignment in the second establishment module is represented as:

$$\\ {max}_{F , {\{ {W}_{p} \}}_{p = 1}^{m} , β} {\sum }_{i = 1}^{n} ( Tr ( {F}^{T} {\sum }_{p = 1}^{m} {β}_{p} \tilde{H} {}_{p}^{( i )} {W}_{p} ) + λ Tr ( {F}^{T} {\tilde{M}}_{i} ) )$$

$$\\ s . t . \tilde{H} {}_{p}^{( i )} = {( {A}_{p}^{( i )} )}^{T} {H}_{p} , {\tilde{M}}_{i} = {( {A}_{p}^{( i )} )}^{T} M$$

$$\\ {F}^{T} F = {I}_{k} , {W}^{T} W = {I}_{k} , {‖ β ‖}_{2} = 1 , {β}_{p} \geq 0$$

where Aₚ⁽ⁱ⁾ represents an indicator matrix of τ neighbors in sample i in the p^{th} view, that is, a neighbor matrix of each view; n represents the number of samples; \tilde{H}ₚ⁽ⁱ⁾ represents a basic partition matrix with the i^{th} sample local information in the p^{th} view; {Wₚ}ₚ₌₁^{m} represents a permutation matrix of each view; λ represents a regularization parameter; \tilde{M}ᵢ represents an average partition matrix with the i^{th} sample local information; and (Aₚ⁽ⁱ⁾)^{T} represents a permutation of Aₚ⁽ⁱ⁾.

Compared with the prior art, the present application provides a novel late fusion multi-view clustering machine learning method based on local maximum alignment, and the method includes acquiring a neighbor matrix and basic partition of each view, and constructing an objective function by using local information of each view. Then, an optimal partition matrix with a local structure is learned through optimization, and therefore the purpose of improving the clustering effect is achieved. Meanwhile, the present application can also solve the clustering problem on large-scale data. Experimental results on 8 multi-kernel datasets (including 6 benchmark datasets and 2 large-scale datasets) demonstrated superior performance of the present application over existing methods.

### BRIEF DESCRIPTION OF THE DRAWINGS

FIG. 1 is a flowchart of a late fusion multi-view clustering method based on local maximum alignment according to Embodiment 1;

FIGS. 2A-2F show a schematic diagram of the variation of an objective function value as the number of iterations increases according to Embodiment 2; and

FIGS. 3A-3F show a schematic diagram of parameter sensitivity according to Embodiment 2.

### DETAILED DESCRIPTION OF THE EMBODIMENTS

The following describes the embodiments of the present application by specific examples, and other advantages and effects of the present application will be readily apparent to those skilled in the art from the disclosure of the present application. The present application can also be implemented or applied through other different specific embodiments, and various modifications or changes can be made to the details in this specification based on different viewpoints and applications without departing from the spirit of the present application. It should be noted that the following embodiments and features in the embodiments can be combined with each other without conflict.

For the defects of the prior art, an objective of the present application is to provide a late fusion multi-view clustering method and system based on local maximum alignment.

### Embodiment 1

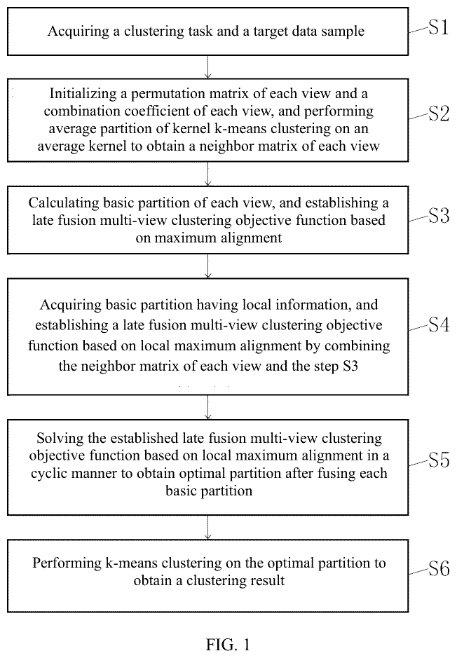

This embodiment provides a late fusion multi-view clustering method based on local maximum alignment, as shown in FIG. 1, which includes the following steps:
S1: acquiring a clustering task and a target data sample;
S2: initializing a permutation matrix of each view and a combination coefficient of each view, and performing average partition of kernel k-means clustering on an average kernel to obtain a neighbor matrix of each view;
S3: calculating basic partition of each view, and establishing a late fusion multi-view clustering objective function based on maximum alignment;
S4: acquiring basic partition having local information, and establishing a late fusion multi-view clustering objective function based on local maximum alignment by combining the neighbor matrix of each view and the step S3;
S5: solving the established late fusion multi-view clustering objective function based on local maximum alignment in a cyclic manner to obtain optimal partition after fusing each basic partition; and
S6: performing k-means clustering on the optimal partition to obtain a clustering result.

According to the late fusion multi-view clustering method based on local maximum alignment, the basic partition matrix has local clustering structure information, so that the optimal partition obtained through learning has a better clustering structure.

In the step S2, a permutation matrix of each view and a combination coefficient of each view are initialized, and average partition of kernel k-means clustering is performed on an average kernel to obtain a neighbor matrix of each view.

The permutation matrix of each matrix is set as {Wₚ}ₚ₌₁^{m}, the combination coefficient of each view is set as β, the average partition of kernel k-means clustering performed on an average kernel is set as M, a neighbor matrix of each view is set as Aₚ⁽ⁱ⁾, and the above data is initialized.

In this embodiment, the basic partition is first obtained by kernel k-means clustering. Assuming that a sample set is X={x₁, . . . , xₙ}⊆χ, where χ is the sample space. A kernel function is set as κ:χ×χ→R, a corresponding kernel matrix K∈R^{n×n} is obtained, and the element in this matrix Kᵢⱼ=κ(xᵢ, xⱼ). The objective formula of kernel k-means clustering is as follows:

$$\\ {min}_{{H}^{T} H = {I}_{k}} Tr ( K ( {I}_{m} - {HH}^{T} )$$

where H∈R^{n×k} represents a partition matrix solved according to the kernel matrix K; Iₘ represents an identity matrix with a dimension of m(∈N⁺); H^{T} represents the permutation of H; and Iₖ represents a k-dimensional identity matrix. The above formula can be solved by performing eigendecomposition on K, and the solution is the eigenvector corresponding to K maximum eigenvalues before K.

In the step S3, the basic partition of each view is calculated, and a late fusion multi-view clustering objective function based on maximum alignment is established.

In this embodiment, different kernel matrices {Kₚ}ₚ₌₁^{m} can be constructed for different views, and kernel k-means clustering is performed to obtain the basic partition {Hₚ}ₚ₌₁^{m} of each view. The late fusion multi-view clustering objective function based on maximum alignment is as follows:

$${max}_{F , {\{ {W}_{p} \}}_{p = 1}^{m} , β} Tr ( {F}^{T} X ) + λ T r ( {F}^{T} M )$$

$$s . t . {F}^{T} F = {I}_{k} , {W}_{p}^{T} {W}_{p} = {I}_{k} , {‖ β ‖}_{2} = 1 , {β}_{p} \geq 0 , X = {\sum }_{p = 1}^{m} {β}_{p} {H}_{p} {W}_{p}$$

where F represents an optimized optimal partition; β represents a vector formed by the combination coefficients of each view, βₚ represents a coefficient of the p^{th} view, and {Wₚ}ₚ₌₁^{m} represents a permutation matrix of each view; m represents average partition obtained by performing kernel k-means clustering on the average kernel; F^{T} represents a permutation of F; W^{T} represents a permutation of W; Hₚ represents the basic partition of each view obtained by kernel k mean clustering; and m represents the number of views.

The optimization of F can be obtained by performing economic singular value decomposition on X+λM and taking the product of left and right singular value vectors; the optimization of β can be obtained by using the condition that the equal sign of the Cauchy-Bunyakovsky-Schwarz inequality is established; and the optimization the Wₚ can be obtained by performing singular value decomposition on the F^{T}Hₚ and taking the product of the left and the right singular value vectors.

In the step S4, basic partition having local information is obtained, and a late fusion multi-view clustering objective function based on local maximum alignment is established by combining the neighbor matrix of each view and the step S3.

The basic partition used in the method in the step S3 only has the global clustering structure of each view, and ignores the local clustering structure. This embodiment has matrix Aₚ⁽ⁱ⁾∈{0,1}^{n×n} representing an indicator matrix of whether the p^{th} view is τ neighbor in sample i. Accordingly, a basic partition matrix \tilde{H}ₚ⁽ⁱ⁾=(Aₚ⁽ⁱ⁾)^{T}Hₚ having the i^{th} sample local information in the p^{th} view and an average partition matrix \tilde{M}ᵢ=(Aₚ⁽ⁱ⁾)^{T}M with the i^{th} sample local information can be defined, where M is the average partition obtained by performing kernel k-means clustering on the average kernel.

The late fusion multi-view clustering objective function based on local maximum alignment is as follows:

$${max}_{F , {\{ {W}_{p} \}}_{p = 1}^{m} , β} {\sum }_{i = 1}^{n} ( T r ( {F}^{T} {\sum }_{p = 1}^{m} {β}_{p} {\tilde{H}}_{p}^{( i )} {W}_{p} ) + λ T r ( {F}^{T} {\tilde{M}}_{i} ) )$$

$$s . t . {\tilde{H}}_{p}^{( i )} = {( {A}_{p}^{( i )} )}^{T} {H}_{p} , {\tilde{M}}_{i} = {( {A}_{p}^{( i )} )}^{T} M$$

$${F}^{T} F = {I}_{k} , {W}_{p}^{T} {W}_{p} = {I}_{k} , {‖ β ‖}_{2} = 1 , {β}_{p} \geq 0$$

where Aₚ⁽ⁱ⁾ represents an indicator matrix of τ neighbors in sample i in the p^{th} view, that is, a neighbor matrix of each view; n represents the number of samples; \tilde{H}ₚ⁽ⁱ⁾ represents a basic partition matrix with the i^{th} sample local information in the p^{th} view; {Wₚ}ₚ₌₁^{m} represents a permutation matrix of each view; λ represents a regularization parameter; \tilde{M}ᵢ represents an average partition matrix with the i^{th} sample local information; and (Aₚ⁽ⁱ⁾)^{T} represents a permutation of Aₚ⁽ⁱ⁾.

In the step S5, the established late fusion multi-view clustering objective function based on local maximum alignment is solved in a cyclic manner to obtain optimal partition after fusing each basic partition.

In this embodiment, a three-step alternating optimization method is used to solve the objective function in the step S4, which specifically includes:
A1: fixing {Wₚ}ₚ₌₁^{m} and β, and optimizing F, where the optimization problem is converted to the following formula:

$${max}_{F} Tr ( {F}^{T} U ) , s . t . {F}^{T} F = {I}_{k}$$

where U=Σᵢ₌₁ⁿ(Σₚ₌₁^{m}βₚ\tilde{H}ₚ⁽ⁱ⁾Wₚ+λ\tilde{M}ᵢ), assuming that a singular value of the rank k of U is decomposed into U=SₖΣₖVₖ^{T}, where Sₖ∈R^{n×k} represents a left singular value vector, Eₖ∈R^{k×k} represents a diagonal matrix with singular values as elements, Vₖ∈R^{k×k} represents a right singular value vector, and then a closed-form solution F=SₖVₖ^{T} is obtained, and Vₖ^{T} represents Vₖ permutation;
A2: fixing F and β, optimizing {Wₚ}ₚ₌₁^{m}, and independently optimizing each Wₚ, where an optimization formula is represented as:

$${max}_{{W}_{p}} Tr ( {W}_{p}^{T} L ) , s . t . {W}_{p}^{T} {W}_{p} = {I}_{k}$$

where L=Σᵢ₌₁ⁿβₚ(\tilde{H}ₚ⁽ⁱ⁾)^{T}F, assuming that a singular value of L is decomposed into L=SΣV^{T}, where S∈R^{k×k} represents a left singular value vector, Σ∈R^{k×k} represents a diagonal matrix with singular values as elements, V∈R^{k×k} represents a right singular value vector, and then a closed-form solution Wₚ=SV is obtained;
A3: fixing {Wₚ}ₚ₌₁^{m} and F, and optimizing β, where an optimization formula is represented as:

$${max}_{β} {\sum }_{p = 1}^{m} {β}_{p} {δ}_{P} , s . t . {‖ β ‖}_{2} = 1 , {β}_{p} \geq 0$$

where δₚ=Σᵢ₌₁ⁿTr(F^{T}\tilde{H}ₚ⁽ⁱ⁾Wₚ), a closed-form solution βₚ=δₚ/\sqrt{Σₚ₌₁^{m}δₚ²} is obtained by using a condition that the equal sign of the Cauchy-Bunyakovsky-Schwarz inequality is taken.

The termination condition of the alternating method of steps A1-A3 is represented as:

(obj^{(t-1)}−obj^{(t)}/obj^{(t)}≤ε

where obj^{(t-1)} and obj^{(t)} represent values of the objective function for the t^{th} iteration and t−1^{th} iteration; and ε represents the set precision.

In the step S6, k-means clustering is performed on the optimal partition to obtain a clustering result. The obtained partition is a variable F in the objective function in the step S4, and each row of F is regarded as a sample, and k-means clustering is performed on the sample to obtain a final clustering result.

This embodiment includes acquiring a neighbor matrix and basic partition of each view, constructing an objective function by using local information of each view, and then learning an optimal partition matrix with a local structure through optimization; therefore the purpose of improving the clustering effect is achieved.

### Embodiment 2

The late fusion multi-view clustering method based on local maximum alignment provided by this embodiment is different from Embodiment 1 in that:
the technical solution of this embodiment is applied to an image dataset, which specifically includes:
S1: acquiring a clustering task and a target data sample related to an image;
S2: initializing a permutation matrix of each view and a combination coefficient of each view, and performing average partition of kernel k-means clustering on an average kernel to obtain a neighbor matrix of each view;
S3: calculating basic partition of each view, and establishing a late fusion multi-view clustering objective function based on maximum alignment;
S4: acquiring basic partition having local information, and establishing a late fusion multi-view clustering objective function based on local maximum alignment by combining the neighbor matrix of each view and the step S3;
S5: solving the established late fusion multi-view clustering objective function based on local maximum alignment in a cyclic manner to obtain optimal partition after fusing each basic partition; and
S6: performing k-means clustering on the optimal partition to obtain a clustering result.

The image datasets include a face image dataset, a plant image dataset, a handwritten Arabic numeral image dataset, a medical image dataset, an object behavior and action posture, business order data, mass order grouping, order wave order combination, order data mining and analysis, inventory allocation, goods shelf adjustment, supply chain optimization, intelligent replenishment, and the like.

This embodiment takes a face as an example for explanation.

The clustering performance of this method is tested on 6 multi-kernel standard datasets (including 5 benchmark datasets and 1 large-scale dataset).

The 6 multi-kernel standard datasets include AR10P, YALE, Plant, Caltech102-30 (Cal102-30 for short), Flower17, and Mnist. AR10P is a database of face images, where each person has photos taken in different situations such as facial expressions, lighting, or disguise. YALE faces contain 165 pictures from 15 people, each person's photos are taken in different facial expressions, postures, or lighting conditions. Plant and Flower17 are datasets of plant images. Caltech102 is a dataset composed of 102 different types of item photos. 30 samples are selected from each category as a training set that is denoted as Caltech102-30. Mnist is a large-scale dataset that contains 60000 handwritten Arabic numeral images to validate the performance of the algorithm on large-scale datasets. Table 1 shows relevant information on the dataset. The kernel matrices of all datasets can be downloaded from the internet.

TABLE 1
7 multi-kernel standard datasets

| Dataset | Samples | Kernels | Clusters |
|---|---|---|---|
| AR10P | 130 | 6 | 10 |
| YALE | 165 | 5 | 15 |
| Plant | 940 | 69 | 4 |
| Cal102-30 | 3060 | 48 | 102 |
| Flower17 | 1360 | 7 | 17 |
| CCV | 6773 | 3 | 20 |
| Mnist | 60000 | 3 | 10 |

In this experiment, an average multi-kernel k-means clustering algorithm (AMKKM), an optimal single-view kernel k-means clustering algorithm (SB-KKM), a multi-kernel k-means clustering (MKKM), a collaborative regularization spectral clustering (CRSC), a robust multi-kernel clustering (RMKKM), a robust multi-view spectral clustering (RMSC), a local multi-kernel k-means clustering (LMKKM), a multi-kernel k-means clustering with a matrix induction regularization term (MKKM-MR), and a multi-kernel clustering based on local kernel maximum alignment (LKAM) are used. In all experiments, all benchmark kernels are first centered and regularized. For all datasets, assuming that the number of categories is known and set as the number of clustering categories. The contrastive algorithm used in this experiment all set parameters according to the corresponding literature. The parameter λ of this method is determined by the range of grid search [2⁻⁵, 2⁻⁴, . . . , 2⁵], and the parameter τ is determined by the range of grid search [0.1, 0.2, . . . , 1].

This experiment used common clustering accuracy (ACC) and normalized mutual information (NMI) to show the clustering performance of each method. All methods were randomly initialized and repeated 50 times and showed the optimal results to reduce the randomness caused by k-means.

TABLE 2
Clustering performance of different algorithms on five benchmark datasets

| | | | | | | | | | | |
|---|---|---|---|---|---|---|---|---|---|---|
| | A- | SB- | | | | | | MKKM- | | |
| Dataset | MKKM | KKM | MKKM | CRSC | RMKKM | RMSC | LMKKM | MR | LKAM | Proposed |

ACC (%)

| | | | | | | | | | | |
|---|---|---|---|---|---|---|---|---|---|---|
| AR10P | 38.46 | 43.08 | 40.00 | 32.31 | 30.77 | 30.77 | 40.77 | 39.23 | 27.69 | 53.08 |
| YALE | 52.12 | 56.97 | 52.12 | 52.36 | 56.36 | 58.03 | 53.33 | 58.00 | 46.67 | 60.61 |
| Plant | 60.21 | 51.91 | 56.38 | 60.21 | 55.00 | 53.62 | — | 52.55 | 50.32 | 64.79 |
| Cal102- | 25.91 | 27.29 | 16.31 | 26.51 | 21.41 | 22.58 | — | 30.31 | 24.54 | 34.17 |
| 30 | | | | | | | | | | |
| Flower17 | 51.03 | 42.06 | 45.37 | 46.02 | 53.38 | 51.10 | 48.97 | 58.82 | 57.87 | 62.35 |

NMI (%)

| | | | | | | | | | | |
|---|---|---|---|---|---|---|---|---|---|---|
| AR10P | 37.27 | 42.61 | 39.53 | 33.32 | 26.62 | 27.87 | 41.67 | 40.11 | 24.72 | 53.11 |
| YALE | 57.72 | 58.42 | 54.16 | 54.65 | 2.48 | 57.58 | 56.60 | 58.87 | 53.51 | 60.50 |
| Plant | 25.54 | 17.19 | 20.02 | 25.54 | 19.43 | 23.18 | — | 21.65 | 21.46 | 30.94 |
| Cal102- | 49.31 | 50.85 | 39.92 | 48.25 | 43.72 | 46.04 | — | 51.55 | 47.39 | 53.49 |
| 30 | | | | | | | | | | |
| Flower17 | 50.19 | 45.14 | 45.35 | 45.69 | 52.56 | 54.39 | 47.79 | 57.05 | 56.06 | 59.39 |

Table 2 shows the clustering effect of this method (Proposed) and the contrastive algorithm on five benchmark datasets, and the notation “-” represents memory overflow, and the algorithm cannot run. It can be seen from this table that: 1. this method is superior to all contrastive algorithms under two evaluation criteria. 2. The performance of this method on six datasets ACC is respectively 12.31%, 2.58%, 4.58%, 3.86%, and 3.53% higher than that of the suboptimal contrastive algorithm. Table 3 shows the performance of this method on large scale datasets. It can be seen from Table 3 that, when many contrastive algorithms cannot run due to memory overflow, this method can not only run smoothly, but also obtain the significant effect. This demonstrates the effectiveness of this method on large-scale datasets.

TABLE 3
Clustering performance of different algorithms
on two large-scale datasets

| | | | | | |
|---|---|---|---|---|---|
| Datasets | A-MKKM | SB-KKM | CRSC | MKKM-MR | Proposed |

ACC (%)

| | | | | | |
|---|---|---|---|---|---|
| Mnist | 77.33 | 77.89 | — | — | 82.85 |

NMI (%)

| | | | | | |
|---|---|---|---|---|---|
| Mnist | 74.28 | 76.50 | — | — | 80.87 |

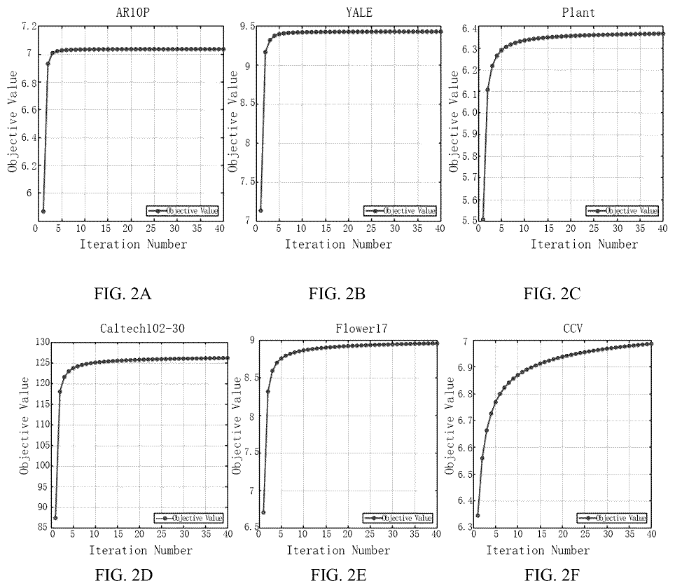

This example also shows the variation of the objective function at each iteration, as shown in FIGS. 2A-2F. It can be seen that the objective function value monotonically increases and usually converges within 40 iterations.

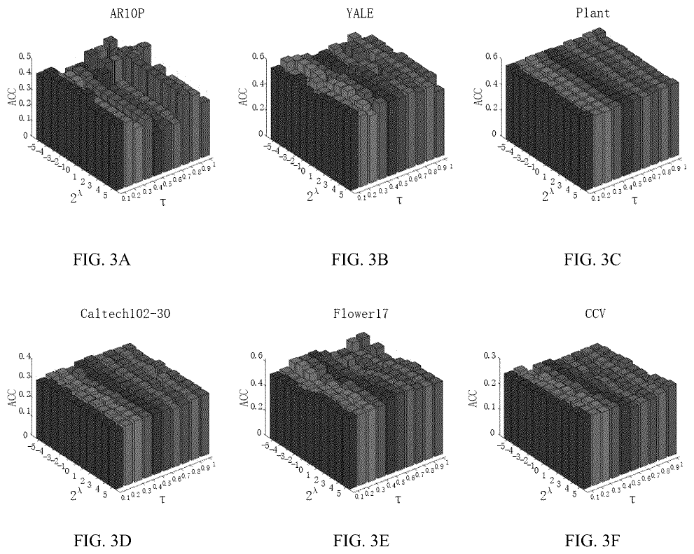

FIGS. 3A-3F show parameter sensitivity. It can be seen from the figure that 1) the variation of the parameters can obtain better performance in a large range; 2) the clustering performance on some datasets is relatively sensitive to parameters, and when the value of τ is 0.1, the overall effect is better. This has an instructive effect on the selection of the hyperparameters.

This embodiment can solve the clustering problem on large-scale data. Experimental results on 7 multi-kernel image datasets (including 5 benchmark datasets and 1 large-scale dataset) demonstrated superior performance of this method over existing methods.

### Embodiment 3

This embodiment further provides a late fusion multi-view clustering system based on local maximum alignment, which includes:
an acquisition module configured to acquire a clustering task and a target data sample;
an initialization module configured to initialize a permutation matrix of each view and a combination coefficient of each view, and perform average partition of kernel k-means clustering on an average kernel to obtain a neighbor matrix of each view;
a first establishment module configured to calculate basic partition of each view, and establish a late fusion multi-view clustering objective function based on maximum alignment;
a second establishment module configured to acquire basic partition having local information, and establish a late fusion multi-view clustering objective function based on local maximum alignment by combining the neighbor matrix of each view and the objective function in the first establishment module;
a solving module configured to solve the established late fusion multi-view clustering objective function based on local maximum alignment in a cyclic manner to obtain optimal partition after fusing each basic partition; and
a clustering module configured to perform k-means clustering on the optimal partition to obtain a clustering result.

Further, the establishing a late fusion multi-view clustering objective function based on maximum alignment in the first establishment module is represented as:

$${max}_{F , {\{ {W}_{p} \}}_{p = 1}^{m} , β} Tr ( {F}^{T} X ) + λ T r ( {F}^{T} M )$$

$$s . t . {F}^{T} F = {I}_{k} , {W}_{p}^{T} {W}_{p} = {I}_{k} , {‖ β ‖}_{2} = 1 , {β}_{p} \geq 0 , X = {\sum }_{p = 1}^{m} {β}_{p} {H}_{p} {W}_{p}$$

where F represents an optimized optimal partition; β represents a vector formed by the combination coefficients of each view, βₚ represents a coefficient of the p^{th} view, and {Wₚ}ₚ₌₁^{m} represents a permutation matrix of each view; m represents average partition obtained by performing kernel k-means clustering on the average kernel; F^{T} represents a permutation of F; W^{T} represents a permutation of W; Hₚ represents the basic partition of each view obtained by kernel k mean clustering; and m represents the number of views.

Further, the establishing a late fusion multi-view clustering objective function based on local maximum alignment in the second establishment module is represented as:

$${max}_{F , {\{ {W}_{p} \}}_{p = 1}^{m} , β} {\sum }_{i = 1}^{n} ( T r ( {F}^{T} {\sum }_{p = 1}^{m} {β}_{p} {\tilde{H}}_{p}^{( i )} {W}_{p} ) + λ T r ( {F}^{T} {\tilde{M}}_{i} ) )$$

$$s . t . {\tilde{H}}_{p}^{( i )} = {( {A}_{p}^{( i )} )}^{T} {H}_{p} , {\tilde{M}}_{i} = {( {A}_{p}^{( i )} )}^{T} M$$

$${F}^{T} F = {I}_{k} , {W}_{p}^{T} {W}_{p} = {I}_{k} , {‖ β ‖}_{2} = 1 , {β}_{p} \geq 0$$

where Aₚ⁽ⁱ⁾ represents an indicator matrix of τ neighbors in sample i in the p^{th} view, that is, a neighbor matrix of each view; n represents the number of samples; \tilde{H}ₚ⁽ⁱ⁾ represents a basic partition matrix with the i^{th} sample local information in the p^{th} view; {Wₚ}ₚ₌₁^{m} represents a permutation matrix of each view; λ represents a regularization parameter; \tilde{M}ᵢ represents an average partition matrix with the i^{th} sample local information; and (Aₚ⁽ⁱ⁾)^{T} represents a permutation of Aₚ⁽ⁱ⁾.

It should be noted that the late fusion multi-view clustering system based on local maximum alignment provided in this embodiment is similar to Embodiment 1. Details are not described herein again.

This embodiment includes acquiring a neighbor matrix and basic partition of each view, constructing an objective function by using local information of each view, and then learning an optimal partition matrix with a local structure through optimization; therefore the purpose of improving the clustering effect is achieved.

It should be noted that the foregoing are merely some embodiments of the present application and applied technical principles. Those skilled in the art may understand that the present application is not limited to specific embodiments described herein, and those skilled in the art may make various significant changes, readjustments, and replacements without departing from the protection scope of the present application. Therefore, although the present application is described in detail by using the foregoing embodiments, the present application is not limited to the foregoing embodiments, and may further include more other equivalent embodiments without departing from the concept of the present application. The scope of the present application is determined by the scope of the appended claims.

What is claimed is:

1. A late fusion multi-view clustering method based on a local maximum alignment, comprising the following steps:
S1: acquiring a clustering task and a target data sample;
S2: initializing a permutation matrix of each view and a combination coefficient of each view, and performing an average partition of a kernel k-means clustering on an average kernel to obtain a neighbor matrix of each view;
S3: calculating a basic partition of each view, and establishing a late fusion multi-view clustering objective function based on a maximum alignment;
S4: acquiring a basic partition having local information, and establishing a late fusion multi-view clustering objective function based on the local maximum alignment by combining the neighbor matrix of each view and the step S3;
S5: solving the established late fusion multi-view clustering objective function based on the local maximum alignment in a cyclic manner to obtain an optimal partition after fusing each basic partition; and
S6: performing k-means clustering on the optimal partition to obtain a clustering result.

2. The late fusion multi-view clustering method according to claim 1, wherein the kernel k-means clustering in the step S2 is represented as:
$${min}_{{H}^{T} H = {I}_{k}} T r ( K ( {I}_{m} - H {H}^{T} )$$
wherein H∈R^{n×k} represents a partition matrix solved according to the kernel matrix K; Iₘ represents an identity matrix with a dimension of m(∈N⁺); H^{T} represents a permutation of H; and Iₖ represents a k-dimensional identity matrix.

3. The late fusion multi-view clustering method according to claim 2, wherein the operation of calculating the basic partition of each view in the step S3 comprises: constructing different kernel matrices {Kₚ}ₚ₌₁^{m} for different views, and operating the kernel k-means clustering to obtain the basic partition {Hₚ}ₚ₌₁^{m} of each view.

4. The late fusion multi-view clustering method according to claim 3, wherein the operation of establishing the late fusion multi-view clustering objective function based on the maximum alignment in the step S3 is represented as:
$${max}_{F , {\{ {W}_{p} \}}_{p = 1}^{m} , β} Tr ( {F}^{T} X ) + λ T r ( {F}^{T} M )$$
$$s . t . {F}^{T} F = {I}_{k} , {W}_{p}^{T} {W}_{p} = {I}_{k} , {‖ β ‖}_{2} = 1 , {β}_{p} \geq 0 , X = {\sum }_{p = 1}^{m} {β}_{p} {H}_{p} {W}_{p}$$
wherein F represents an optimized optimal partition; β represents a vector formed by the combination coefficients of each view, βₚ represents a coefficient of a p^{th} view, and {Wₚ}ₚ₌₁^{m} represents a permutation matrix of each view; m represents the average partition obtained by performing the kernel k-means clustering on the average kernel; F^{T} represents a permutation of F; W^{T} represents a permutation of W; Hₚ represents the basic partition of each view obtained by kernel k mean clustering; and m represents a number of views.

5. The late fusion multi-view clustering method according to claim 4, wherein the operation of establishing the late fusion multi-view clustering objective function based on the local maximum alignment in the step S4 is represented as:
$${max}_{F , {\{ {W}_{p} \}}_{p = 1}^{m} , β} {\sum }_{i = 1}^{n} ( T r ( {F}^{T} {\sum }_{p = 1}^{m} {β}_{p} {\tilde{H}}_{p}^{( i )} {W}_{p} ) + λ T r ( {F}^{T} {\tilde{M}}_{i} ) )$$
$$s . t . {\tilde{H}}_{p}^{( i )} = {( {A}_{p}^{( i )} )}^{T} {H}_{p} , {\tilde{M}}_{i} = {( {A}_{p}^{( i )} )}^{T} M$$
$${F}^{T} F = {I}_{k} , {W}_{p}^{T} {W}_{p} = {I}_{k} , {‖ β ‖}_{2} = 1 , {β}_{p} \geq 0$$
wherein Aₚ⁽ⁱ⁾ represents an indicator matrix of τ neighbors in sample i in the p^{th} view, that is, a neighbor matrix of each view; n represents a number of samples; \tilde{H}ₚ⁽ⁱ⁾ represents a basic partition matrix with an i^{th} sample local information in the p^{th} view; {Wₚ}ₚ₌₁^{m} represents the permutation matrix of each view; λ represents a regularization parameter; \tilde{M}ᵢ represents an average partition matrix with the i^{th} sample local information; and (Aₚ⁽ⁱ⁾)^{T} represents a permutation of Aₚ⁽ⁱ⁾.

6. The late fusion multi-view clustering method according to claim 5, wherein the operation of solving the established late fusion multi-view clustering objective function based on the local maximum alignment in the cyclic manner in the step S5 comprises:
A1: fixing {Wₚ}ₚ₌₁^{m} and β, and optimizing F, wherein an optimization formula is represented as:
$${max}_{F} Tr ( {F}^{T} U ) , s . t . {F}^{T} F = {I}_{k}$$
wherein U=Σᵢ₌₁ⁿ(Σₚ₌₁^{m}βₚ\tilde{H}ₚ⁽ⁱ⁾Wₚ+λ\tilde{M}ᵢ), assuming that a singular value of the rank k of U is decomposed into U=SₖΣₖVₖ^{T}, wherein Sₖ∈R^{n×k} represents a left singular value vector, Eₖ∈R^{k×k} represents a diagonal matrix with singular values as elements, Vₖ∈R^{k×k} represents a right singular value vector, and a closed-form solution F=SₖVₖ^{T} is obtained, and Vₖ^{T} represents Vₖ permutation;
A2: fixing F and β, optimizing {Wₚ}ₚ₌₁^{m}, and independently optimizing each Wₚ, wherein an optimization formula is represented as:
$${max}_{{W}_{p}} Tr ( {W}_{p}^{T} L ) , s . t . {W}_{p}^{T} {W}_{p} = {I}_{k}$$
wherein L=Σᵢ₌₁ⁿβₚ(\tilde{H}ₚ⁽ⁱ⁾)^{T}F, assuming that a singular value of L is decomposed into L=SΣV^{T}, wherein S∈R^{k×k} represents a left singular value vector, Σ∈R^{k×k} represents a diagonal matrix with singular values as elements, V∈R^{k×k} represents a right singular value vector, and a closed-form solution Wₚ=SV is obtained;
A3: fixing {Wₚ}ₚ₌₁^{m} and F, and optimizing β, wherein an optimization formula is represented as:
$${max}_{β} {\sum }_{p = 1}^{m} {β}_{p} {δ}_{P} , s . t . {‖ β ‖}_{2} = 1 , {β}_{p} \geq 0$$
wherein δₚ=Σᵢ₌₁ⁿTr(F^{T}\tilde{H}ₚ⁽ⁱ⁾Wₚ), a closed-form solution βₚ=δₚ/\sqrt{Σₚ₌₁^{m}δₚ²} is obtained by using a condition that an equal sign of the Cauchy-Bunyakovsky-Schwarz inequality is taken.

7. The late fusion multi-view clustering method according to claim 6, wherein in the step S5, the established late fusion multi-view clustering objective function based on the local maximum alignment is solved in the cyclic manner, a termination condition of the circulation is represented as:
(obj^{(t-1)}−obj^{(t)}/obj^{(t)}≤ε
wherein obj^{(t-1)} and obj^{(t)} represent values of the objective function for a t^{th} iteration and t−1^{th} iteration; and ε represents a set precision.

8. A late fusion multi-view clustering system based on a local maximum alignment, comprising:
an acquisition module configured to acquire a clustering task and a target data sample;
an initialization module configured to initialize a permutation matrix of each view and a combination coefficient of each view, and perform an average partition of a kernel k-means clustering on an average kernel to obtain a neighbor matrix of each view;
a first establishment module configured to calculate a basic partition of each view, and establish a late fusion multi-view clustering objective function based on a maximum alignment;
a second establishment module configured to acquire a basic partition having local information, and establish a late fusion multi-view clustering objective function based on the local maximum alignment by combining the neighbor matrix of each view and the objective function in the first establishment module;
a solving module configured to solve the established late fusion multi-view clustering objective function based on the local maximum alignment in a cyclic manner to obtain an optimal partition after fusing each basic partition; and
a clustering module configured to perform k-means clustering on the optimal partition to obtain a clustering result.

9. The late fusion multi-view clustering system according to claim 8, wherein the operation of establishing the late fusion multi-view clustering objective function based on the maximum alignment in the first establishment module is represented as:
$${max}_{F , {\{ {W}_{p} \}}_{p = 1}^{m} , β} Tr ( {F}^{T} X ) + λ T r ( {F}^{T} M )$$
$$s . t . {F}^{T} F = {I}_{k} , {W}_{p}^{T} {W}_{p} = {I}_{k} , {‖ β ‖}_{2} = 1 , {β}_{p} \geq 0 , X = {\sum }_{p = 1}^{m} {β}_{p} {H}_{p} {W}_{p}$$
wherein F represents an optimized optimal partition; β represents a vector formed by the combination coefficients of each view, βₚ represents a coefficient of a p^{th} view, and {Wₚ}ₚ₌₁^{m} represents a permutation matrix of each view; m represents the average partition obtained by performing the kernel k-means clustering on the average kernel; F^{T} represents a permutation of F; W^{T} represents a permutation of W; Hₚ represents the basic partition of each view obtained by kernel k mean clustering; and m represents a number of views.

10. The late fusion multi-view clustering system according to claim 9, wherein the operation of establishing the late fusion multi-view clustering objective function based on the local maximum alignment in the second establishment module is represented as:
$${max}_{F , {\{ {W}_{p} \}}_{p = 1}^{m} , β} {\sum }_{i = 1}^{n} ( T r ( {F}^{T} {\sum }_{p = 1}^{m} {β}_{p} {\tilde{H}}_{p}^{( i )} {W}_{p} ) + λ T r ( {F}^{T} {\tilde{M}}_{i} ) )$$
$$s . t . {\tilde{H}}_{p}^{( i )} = {( {A}_{p}^{( i )} )}^{T} {H}_{p} , {\tilde{M}}_{i} = {( {A}_{p}^{( i )} )}^{T} M$$
$${F}^{T} F = {I}_{k} , {W}_{p}^{T} {W}_{p} = {I}_{k} , {‖ β ‖}_{2} = 1 , {β}_{p} \geq 0$$
wherein Aₚ⁽ⁱ⁾ represents an indicator matrix of τ neighbors in sample i in the p^{th} view, that is, a neighbor matrix of each view; n represents a number of samples; \tilde{H}ₚ⁽ⁱ⁾ represents a basic partition matrix with an i^{th} sample local information in the p^{th} view; {Wₚ}ₚ₌₁^{m} represents the permutation matrix of each view; λ represents a regularization parameter; \tilde{M}ᵢ represents an average partition matrix with the i^{th} sample local information; and (Aₚ⁽ⁱ⁾)^{T} represents a permutation of Aₚ⁽ⁱ⁾.
